(19) United States
(12) Patent Application Publication
(10) Pub. No.: US 2005/0289335 A1
(43) Pub. Date: Dec. 29, 2005

(54) Boot system, boot method, and data processing apparatus using the boot method

(75) Inventor: Eko Fajar, Fukuoka (JP)

Correspondence Address: SONNENSCHEIN NATH & ROSENTHAL;Sears Tower, Wacker Drive Station, P.O. Box 061080, Chicago, IL, 60606-1080, US

(73) Assignee: Sony Corporation

(21) Appl. No.: 11/166,324

(22) Filed: Jun. 24, 2005

(30) Foreign Application Priority Data
Jun. 25, 2004 (JP) P2004-188335

(51) Int. Cl. G06F 15/177

(52) U.S. Cl. 713/1

(57) ABSTRACT

A boot system is provided for storing boot data into respective ones of a plurality of data storage means provided in a processing means that executes a process, and to thereby boot the processing means, the system including a boot data storage means provided to each of the data storage means, for storing the boot data into the data storage means from the boot data storage means simultaneously in accordance with booting.

### CROSS REFERENCE TO RELATED APPLICATONS

The present document contains subject matter related to Japanese Patent Application JP2004-188335, filed to the Japanese Patent Office on Jun. 25, 2004, the entire contents of which being incorporated herein by reference.

### BACKGROUND OF THE INVENTION

1. Field of the Invention

The present invention relates to a boot system and a boot method for a data processing apparatus such as a microcomputer, and to a data processing apparatus using this boot method.

2. Related Art

In the related art, in a data processing apparatus such as a microcomputer, the operation of which is controlled on the basis of a required program, a boot program is executed which initializes the data processing apparatus upon supply of the power (e.g., see Patent Document 1). The operation of initializing a data processing apparatus in this way is called simply “booting”.

In the data processing apparatus, codes of the boot program are successively executed in accordance with booting, to store required data into data storage means such as registers provided in the data processing apparatus. When the required data has been stored into all the required data storage means, booting is completed.

[Patent Document 1] Japanese Patent Laid-Open No. 10-116187

### SUMMARY OF THE INVENTION

However, where booting is performed on the basis of boot programs as mentioned above, a high level of versatility is provided in which the initialized status can be changed by changing the boot program on one hand, but a tremendous amount of time is entailed to successively execute the program codes on the other. As a result, it takes long time for the data processing apparatus to get ready for use, and this has imposed a problem that the user must wait for such extended time.

In view of such circumstances, the present inventors carried out their research in order to develop a system capable of completing booting within a relatively short time, and conceived the present invention.

A boot system according to a preferred embodiment of the present invention includes a boot system for storing boot data into respective ones of a plurality of data storage means provided in a processing means that executes a predetermined process, to boot the processing means. The boot system is configured such that boot data storage means for storing the boot data are provided, one for each of the data storage means, to store the boot data into the data storage means from the boot data storage means simultaneously in accordance with booting.

Further, it has a feature that the boot data storage means are daisy-chained to each other, and that the boot data is sequentially transferred thereto in accordance with booting, to store predetermined items of the boot data into predetermined ones of the boot data storage means. It has another feature that data stored into the data storage means during the process is also stored into the boot data storage means, to use the data stored into the boot data storage means as the boot data in case of rebooting.

Furthermore, a boot method according to a preferred embodiment of the present invention is a boot method for storing boot data into respective ones of a plurality of data storage means provided in a processing means that executes a predetermined process, to boot the processing means. In the boot method, it is configured such that the boot data is stored into the data storage means from boot data storage means for storing the boot data, simultaneously in accordance with booting, the boot data storage means being provided one for each of the data storage means.

Furthermore, a data processing apparatus according to a preferred embodiment of the present invention includes a data processing apparatus for executing a predetermined process on the basis of data stored into data storage means. In the data processing apparatus, there are provided boot data storage means for storing boot data to be stored into the data storage means at time of booting, and a control means for storing the boot data into the data storage means from the boot data storage means in accordance with booting.

Furthermore, the following features are also provided. That is:
(1) The boot data storage means are daisy-chained to each other, and the control means sequentially transfers the boot data to the boot data storage means in accordance with booting, to store predetermined items of the boot data into predetermined ones of the boot data storage means;
(2) The data stored into the data storage means is also stored into the boot data storage means;
(3) At time of rebooting, the data stored into the boot data storage means from the data storage means is used as the boot data; and
(4) There is provided an external output means for outputting the data stored into the boot data storage means from the data storage means, to the outside by sequentially transferring the boot data storage means.

According to a preferred embodiment of the present invention, there is provided a boot system for storing boot data into respective ones of a plurality of data storage means provided in a processing means that executes a predetermined process, to boot the processing means. In the boot system, boot data storage means for storing the boot data are provided, one for each of the data storage means, to store the boot data into the data storage means from the boot data storage means simultaneously in accordance with booting. As a result, input of the boot data into required data storage means can be terminated within an extremely short time, and thus a time required for booting can be shortened.

According to another preferred embodiment of the present invention, the boot data storage means are daisy-chained to each other, and the boot data is sequentially transferred thereto in accordance with booting, to store predetermined items of the boot data into predetermined ones of the boot data storage means. As a result, by thus adjusting the boot data, booting for implementing a required starting state can be performed.

According to another preferred embodiment of the present invention, data stored into the data storage means during the process is also stored into the boot data storage means, to use the data stored into the boot data storage means as the boot data in case of rebooting. As a result, booting can be performed so as to implement a return to a state before the rebooting.

According to another preferred embodiment of the present invention, there is provided a boot method for storing boot data into respective ones of a plurality of data storage means provided in a processing means that executes a predetermined process, to boot the processing means. In the boot method, the boot data is stored into the data storage means from boot data storage means for storing the boot data, simultaneously in accordance with booting, the boot data storage means being provided one for each of the data storage means. As a result, similarly to the invention as claimed in Claim 1, input of the boot data into required data storage means can be terminated within an extremely short time, and thus a time required for booting can be shortened.

According to another preferred embodiment of the present invention, there is provided a data processing apparatus for executing a predetermined process on the basis of data stored into data storage means. In the data processing apparatus, there are provided boot data storage means for storing boot data to be stored into the data storage means at time of booting, one boot data storage means being provided for each of the data storage means, and a control means for storing the boot data into the data storage means from the boot data storage means in accordance with booting. As a result, similarly to the invention as claimed in Claim 1, input of the boot data into required data storage means can be terminated within an extremely short time, and thus a time required for booting can be shortened. Consequently, a so-called instant-on function can be imparted to the data processing apparatus.

According to another preferred embodiment of the present invention, the boot data storage means are daisy-chained to each other, and the control means sequentially transfers the boot data to the boot data storage means in accordance with booting, to store predetermined items of the boot data into predetermined ones of the boot data storage means. As a result, by thus adjusting the boot data, booting for implementing a required starting state can be performed, and thus versatility can be imparted to the data processing apparatus.

According to another preferred embodiment of the present invention, the data stored into the data storage means is also stored into the boot data storage means. As a result, the boot data storage means can be made to function as backups of the data storage means at time of normal operation of the data processing apparatus, and thus the utilization efficiency of the boot data storage means can be enhanced.

According to another preferred embodiment of the present invention, the data stored into the boot data storage means from the data storage means is used as the boot data at time of rebooting. As a result, booting can be performed so as to implement a return to a state before the rebooting.

According to another preferred embodiment of the present invention, there is provided an external output means for outputting the data stored into the boot data storage means from the data storage means, to the outside by sequentially transferring the boot data storage means. As a result, data in the data storage means such as to implement a desired state can be acquired, and status information about the data storage means in case of abnormal suspension of the boot data storage means can also be acquired, and thus debugging operation can be performed extremely easily.

A boot system and a boot method, and a data processing apparatus using this boot method according to another preferred embodiment of the present invention is configured as follows. In a processing means that is configured to execute a predetermined process, where booting is to be performed for storing beforehand boot data into data storage means such as registers provided in these processing means, the boot data is stored into boot data storage means, one being provided for each of the data storage means, to have the boot data stored into the data storage means from the boot data storage means at time of booting.

In other words, unlike a conventional system in which boot data is stored into data storage means on the basis of execution of a boot program, boot data prepared beforehand is inputted directly into the data storage means, to perform booting.

At this event, the boot data is held in the boot data storage means, one being provided for each data storage means, and the boot data is stored into the data storage means from the boot data storage means in accordance with booting, whereby booting can be completed within an extremely short time.

Where this boot method is applied to a data processing apparatus, the data processing apparatus can be started within an extremely short time, and thus a so-called instant-on function can be realized.

Further, the boot data storage means not only have a fixed storage of boot data at all times, but also, when formed into a so-called shift register by daisy-chaining the boot data storage means to each other, can store predetermined items of boot data into predetermined ones of the boot data storage means by sequentially transferring the boot data in accordance with booting.

In this way, by configuring such that required boot data is sequentially transferred to the boot data storage means in accordance with booting, the boot data itself for storage in the boot data storage means can be adjusted, and by adjusting the boot data, a status of the processing means at time the booting has been completed can be adjusted, and thus the versatility can be enhanced.

Furthermore, where data stored in the data storage means during processing of the data by the processing means is to be stored into the boot data storage means, when rebooting occurs, the data stored into the boot data storage means is used, whereby the processing means can be swiftly brought back to a state where it was before the rebooting.

Furthermore, after the data stored in the data storage means into the boot data storage means, these boot data storage means are taken outside after the above-mentioned sequential transfer of the data, whereby operation such as debugging can also be performed.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a circuit diagram of a main portion of a data processing apparatus according to a preferred embodiment of the present invention.

### DESCRIPTION OF THE PREFERRED EMBODIMENTS

Preferred embodiments of the present invention will be described below in great detail with reference to the drawings.

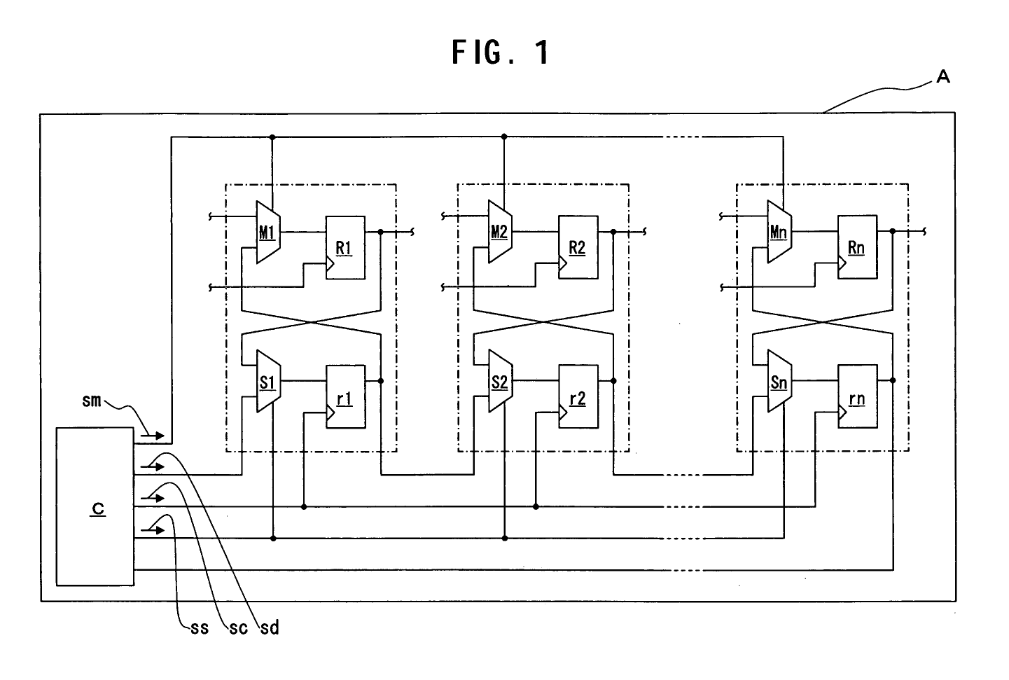

FIG. 1 is a circuit diagram showing a main portion of a data processing apparatus A of the present embodiment. The data processing apparatus A may not be limited to a microprocessor, but may include any type of apparatus as long as the apparatus has required data storage means, such as registers, and requires booting.

In the data processing apparatus A of the present embodiment, there are provided, as data storage means, a first register R1, a second register R2, . . . , an nth register Rn, each of which is formed from a flip-flop. To each of these registers R1, R2, . . . , Rn, a required clock signal is inputted, and each of them operates on the basis of this clock signal.

And a first subregister r1, a second subregister r2, . . . , an nth subregister rn that temporarily store boot data in the registers R1, R2, . . . , Rn are provided for the registers R1, R2, . . . , Rn, respectively. In the present embodiment, each of the subregisters r1, r2, . . . , rn is a flip-flop, and stores the boot data only temporarily, but it may otherwise be configured to store the boot data permanently. Where it is configured to store the boot data permanently, data storage means other than the registers may be used.

Output terminals of these subregisters r1, r2, . . . , rn are connected to input terminals of the registers R1, R2, . . . , Rn through a first mode selector M1, a second mode selector M2, . . . , an nth mode selector Mn, respectively. The mode selectors M1, M2, . . . , Mn switch data for input into the respective registers R1, R2, . . . , Rn on the basis of selection of modes by mode signals sm hereinafter described. As a result, data stored in the subregisters r1, r2, . . . , rn can be stored into the respective registers R1, R2, . . . , Rn.

Further, output terminals of the registers R1, R2, . . . , Rn are connected to input terminals of the subregisters r1, r2, . . . , rn through a first input switching selector S1, a second input switching selector S2, . . . , an nth input switching selector Sn, respectively, whereby data stored in the registers R1, R2, . . . , Rn can be stored into the respective subregisters r1, r2, . . . , rn.

In addition, each of the output terminals of the subregisters r1, r2, . . . , rn is connected to the input terminal of any of the other subregisters r1, r2, . . . , rn through a corresponding one of the input switching selectors S1, S2, . . . , Sn, whereby the subregisters r1, r2, . . . , rn are daisy-chained to each other to form a shift register. Particularly, in the present embodiment, the input terminal of the first subregister r1 is connected to a control section C provided in the data processing apparatus A, through the first input switching selector S1, and also the output terminal of the nth subregister rn is connected to the control section C.

And each of the subregisters r1, r2, . . . , rn is configured to operate on the basis of a control clock signal sc outputted from the control section C provided in the data processing apparatus A.

The control section C is configured to output a mode signal sm for controlling the mode selectors M1, M2, . . . , Mn, and an input control signal ss for controlling the input switching selectors S1, S2, . . . , Sn.

In the case of a boot mode for booting the data processing apparatus A, the control section C outputs a mode signal sm for controlling the mode selectors M1, M2, . . . , Mn such that the boot data stored in the subregisters r1, r2, . . . , rn is stored into the respective register R1, R2, . . . , Rn. In the case of a normal mode which is other than the boot mode, the control section C outputs a mode signal sm for controlling the mode selectors M1, M2, . . . , Mn such that the registers R1, R2, . . . , Rn store required data thereinto.

Further, where data stored in the registers R1, R2, . . . , Rn is to be stored into the respective subregisters r1, r2, . . . , rn, the control section C outputs an input control signal ss for controlling the input switching selectors S1, S2 . . . , Sn such that the data in the registers R1, R2, . . . , Rn is stored into the respective subregisters r1, r2, . . . , rn. In cases other than that, the control section C outputs an input control signal ss for controlling the input switching selectors S1, S2, . . . , Sn such that data stored in other daisy-chained subregisters r1, r2, . . . , rn is stored.

Where booting is to be performed in the data processing apparatus A configured such as described above, the following operation is performed.

First, as the booting begins, the control section C outputs an input control signal ss for controlling the input switching selectors S1, S2, . . . , Sn so as to daisy-chain the subregisters r1, r2, . . . , rn to each other, and also the control section C outputs, for sequential transfer thereto, boot data stored beforehand in a memory, not shown, of the control section C as a data signal sd, while outputting a required control clock signal sc.

At this event, the control section C may output a boot mode signal as the mode signal sm, but, in order to prevent input of incorrect boot data into the registers R1, R2, . . . , Rn, a normal mode signal is outputted as the mode signal sm in the present embodiment, whereby the storing of the data in the subregisters r1, r2, . . . , rn into the respective registers R1, R2, . . . , Rn is prevented.

When the boot data has been inputted as far as to the nth subregister rn through the sequential transfer, the control section C outputs a boot mode signal as the mode signal sm to simultaneously store the boot data stored in the subregisters r1, r2, . . . , rn into the respective registers R1, R2, . . . , Rn.

Thereafter, the control section C outputs a normal mode signal as the mode signal sm to terminate the booting.

In this way, by performing booting while storing the boot data from the subregisters r1, r2, . . . , rn into the respective registers R1, R2, . . . , Rn, the booting can be completed within a short time.

Additionally, the subregisters r1, r2, . . . , rn are daisy-chained to each other, and then the boot data stored in the control section C is sequentially transferred thereto. As a result, by adjusting the boot data for transfer beforehand, a desired booting state can be realized, and this can also enhance the versatility.

Further, in the data processing apparatus A, when the mode is switched to the normal mode after the booting, an input control signal ss to be outputted from the control section C is switched such that data stored in the registers R1, R2, . . . , Rn is stored into the respective subregisters r1, r2, . . . , rn.

In this way, by storing the data stored in the registers R1, R2, . . . , Rn into the respective subregisters r1, r2, . . . , rn, where rebooting is suddenly needed, the data stored in the subregisters r1, r2, . . . , rn is stored into the respective registers R1, R2, . . . , Rn without re-storing the boot data into the subregisters r1, r2, . . . , rn, whereby rebooting to a required state can be performed within an extremely short time.

That is, the subregisters r1, r2, . . . , rn can be made to function as backups of the respective registers R1, R2, . . . , Rn, and thus the utilization efficiency of the subregisters r1, r2, . . . , rn can be enhanced.

Further, data stored into the subregisters r1, r2, . . . , rn from the respective registers R1, R2, . . . , Rn are sequentially transferred after such subregisters r1, r2, . . . , rn have been daisy-chained, whereby the data can be fetched at the control section C.

In this way, status information about data in each of the registers R1, R2, . . . , Rn at a predetermined timing, i.e., snapshot information about each of the registers R1, R2, . . . , Rn can be acquired, and thus debugging operation can be performed easily.

Particularly, in acquiring such snapshot information, data to be stored into the subregisters r1, r2, . . . , rn at a certain timing is the data stored in the registers R1, R2, . . . , Rn one timing behind that timing. Thus, in case of the data processing apparatus A being suspended due to occurrence of an error at a certain data status, the status before the occurrence of the error is stored in the subregisters r1, r2, . . . , rn, and thus debugging operation can be performed extremely easily and properly.

Although the preferred embodiments of the present invention are particularly described above, the present invention is not limited to the above-mentioned preferred embodiments. It will be obvious to those skilled in the art that various changes, modifications, combinations, sub combinations and alterations may be made depending on design requirements and other factors insofar as they are within the scope of the appended claims or equivalents thereof.

1. A boot system for storing boot data into respective ones of a plurality of data storage means provided in a processing means that executes a process, and to thereby boot the processing means, the system comprising:
a boot data storage means provided to each of the data storage means, for storing the boot data into the data storage means from the boot data storage means in accordance with booting.

2. The boot system according to claim 1, wherein the boot data storage means are daisy-chained with one another, and the boot data is sequentially transferred thereto in accordance with booting, to store a designated item of the boot data into a designated boot data storage means.

3. The boot system according to claim 1, wherein the data stored into the data storage means during process is also stored into the boot data storage means, and the data stored into the boot data storage means is used as the boot data in case of rebooting.

4. A boot method for storing boot data into respective ones of a plurality of data storage means provided in a processing means that executes a process, and to thereby boot the processing means, the method comprising the steps of:
storing the boot data in accordance with the booting into the data storage means from a boot data storage means for storing the boot data, the boot data storage means provided for each data storage means.

5. A data processing apparatus for executing a certain process on the basis of data stored into a data storage means, the data processing apparatus comprising:
boot data storage means provided for each data storage means for storing boot data to be stored into the data storage means at time of booting; and
a control means for storing the boot data into the data storage means from the boot data storage means in accordance with booting.

6. The data processing apparatus according to claim 5, wherein the boot data storage means are daisy-chained to one another, and the control means sequentially transfers the boot data to the boot data storage means in accordance with booting, to store certain items of the boot data into certain boot data storage means.

7. The data processing apparatus according to claim 6, wherein the data stored into the data storage means is also stored into the boot data storage means.

8. The data processing apparatus according to claim 7, wherein the data stored into the boot data storage means from the data storage means is used as the boot data at time of rebooting.

9. The data processing apparatus according to claim 7, further comprising an external output means for outputting the data stored into the boot data storage means from the data storage means, by sequentially transferring the boot data storage means.

10. A boot system for storing boot data into respective ones of a plurality of data storage devices provided in a processor that executes a process, and to thereby boot the processor, the system comprising:
a boot data storage device provided to each of the data storage devices, for storing the boot data into the data storage device from the boot data storage device in accordance with booting.

11. A data processing apparatus for executing a certain process on the basis of data stored into a data storage device, the data processing apparatus comprising:
boot data storage device provided for each data storage device for storing boot data to be stored into the data storage device at time of booting; and
a controller for storing the boot data into the data storage device from the boot data storage device in accordance with booting.
